(19) United States
(12) Patent Application Publication
(10) Pub. No.: US 2006/0280911 A1
(43) Pub. Date: Dec. 14, 2006

(54) Universal roofing closure

(76) Inventor: Mark J. Verkamp, Charlesten, AR (US)

Correspondence Address: Stephen R. Greiner, Esquire;GREINER LAW OFFICES, P.C., Suite 110, 6701 Democracy Blvd., Bethesda, MD, 20817, US

(21) Appl. No.: 11/147,316

(22) Filed: Jun. 8, 2005

(51) Int. Cl. B32B 3/30

(52) U.S. Cl. 428/167; 428/156

(57) ABSTRACT

A universal roofing closure including a strip of visco-elastic foam. A strip of closed cell foam is adhesively fastened to the top of said strip of visco-elastic foam and extends the length thereof. Optionally, a ventilation member is adhesively fastened to the top of the strip of closed cell foam. The ventilation member has a multiplicity of open channels running its width so that air can flow from one side of the universal closure to the other.

### FIELD OF THE INVENTION

The present invention relates generally to static structures, e.g., buildings, and, more particularly, to synthetic, resinous or foam components of such structures.

### BACKGROUND OF THE INVENTION

Foam strips or “closures” have long been used to prevent the passage of wind, rain, noise, and animals into buildings with metal roofs. Most foam closures comprise strips of crosslinked polyethylene foam that measure about 0.125″ to 2.5″ in height and 1.5″ in width. The strips have a length of several feet, but are cut-to-measure during installation. In use, the strips are positioned between a corrugated roofing panel and a ridge cap (or other component of a roof) to close openings defined by the ridges and hollows in the roofing panel. Threaded fasteners penetrating the ridge cap, closure, and roofing panel, permanently anchor the closure to the roof thereby providing both a weather-resistant and animal-resistant seal.

To ensure a good seal, notches are cut into the foam strips that match the profile of the corrugated roofing panels with which they will be used as closures. The notches are normally oriented at right angles to the sides of the foam strips; however, when the strips are to be positioned adjacent a roof hip or valley, the notches are inclined somewhat. Although the foam strips can be provided with notches at virtually any angle to yield most conceivable profiles, and some manufacturers provide hundreds, doing so is time-consuming and costly.

### SUMMARY OF THE INVENTION

In light of the problems associated with the known foam closures for roofing applications, it is a principal object of the invention to provide a universal roofing closure that need not be contoured or notched prior to use in the field. Rather, the closure is constructed from such materials that it will compress where the closure contacts the ridges found in a corrugated roofing panel and will expand to perfectly fill the hollows between the ridges. The universal roofing closure is particularly advantageous in filling spaces of unusual shape that are commonly found in roof hips and valleys. Thus, a roofer is no longer required to pre-order closures with different notch configurations prior to initiating a job.

It is another object of the invention to provide a closure of the type described that is virtually impervious to weathering and has a lifespan that is several times that of the crosslinked polyethylene employed in conventional foam closures. It is believed that the materials used in the universal roofing closure described herein have a useful life that can exceed twenty years.

It is an object of the invention to provide improved elements and arrangements thereof in a universal roofing closure for the purposes described that is lightweight in construction, inexpensive to manufacture, and dependable in use.

Briefly, the closure in accordance with this invention achieves the intended objects by featuring . . .

The foregoing and other objects, features and advantages of the present invention will become readily apparent upon further review of the following detailed description of the preferred embodiments as illustrated in the accompanying drawings.

### BRIEF DESCRIPTION OF THE DRAWINGS

The present invention may be more readily described with reference to the accompanying drawings, in which:

FIG. 1 is a cross-sectional view of a universal roofing closure in accordance with the present invention.

FIG. 2 is a cross-sectional view of another universal roofing closure in accordance with the present invention.

FIG. 3 is a perspective view of a building structure wherein areas that the universal roofing closure of the present invention can be employed are indicated.

FIG. 4 is an exploded, cross-sectional view of a roof valley showing the positioning of the universal roofing closure of FIG. 1 therein.

FIG. 5 is an exploded, cross-sectional view of the ridge vent incorporating the universal roofing closure of FIG. 2 therein.

FIG. 6 is a perspective view of the universal roofing closure of FIG. 1 is positioned at junction between a side wall and a roofing panel of a building.

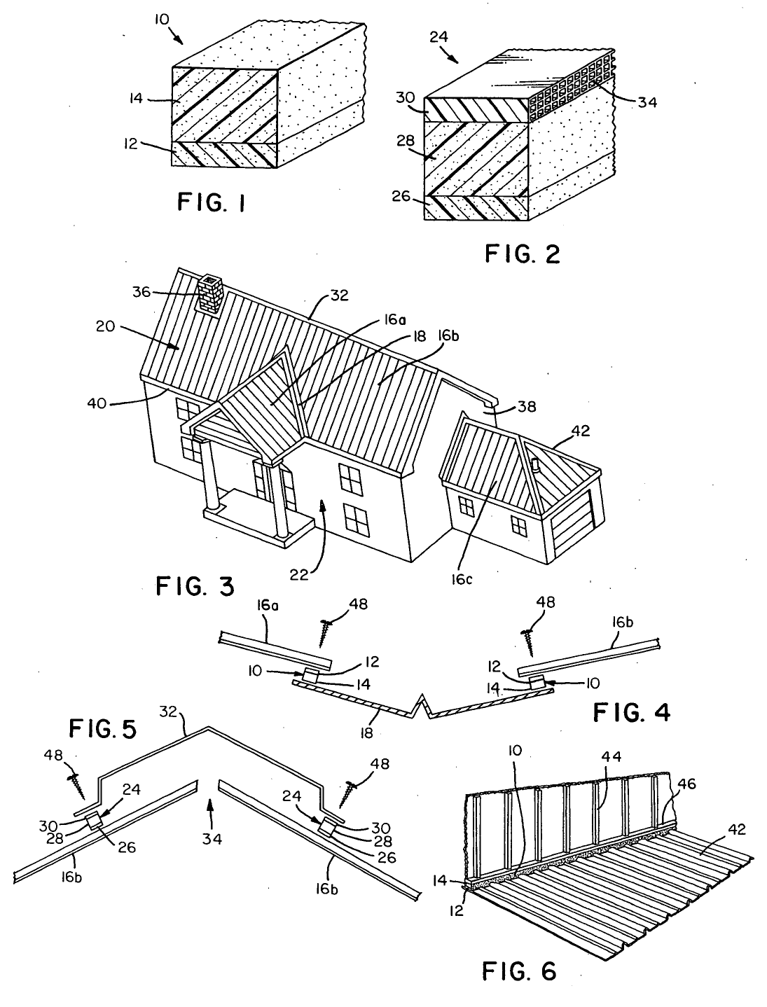

Similar reference characters denote corresponding features consistently throughout the accompanying drawings.

### DETAILED DESCRIPTION OF THE PREFERRED EMBODIMENTS

Referring now to the FIGS., a universal roofing closure in accordance with the present invention is shown at 10. Closure 10 includes an elongated strip of visco-elastic foam 12 on top of which is affixed a strip of closed cell foam 14. When, for example, closure 10 is positioned between a corrugated roofing panel 16a or 16b and a valley trough 18, forming parts of a metal roof 20 of a building 20, strips 12 and 14 expand to fill all adjacent voids to prevent the passage of wind, rain, noise, and animals of all sorts.

Foam strip 12 is formed from a polyurethane-based material commonly referred to as “memory foam.” Memory foam has a density of about four pounds per cubic foot and has a remarkable resiliency. It will conform closely to the contours of irregularly shaped objects pressed into it, yet will spring back to its original form when the object is removed, hence it is now commonly used in bedding. Memory foam is also substantially impermeable to air. One memory foam found suitable for use in closure 10 is marketed as ADAPTAFLEX 400 by Flexible Foam Products, Inc., of Spencerville, Ohio.

Prior to its installation on roof 20, foam strip 12 has an even width and height along its length. The width of strip 12 is about two inches (5 cm) and the height of strip 12 is about one-half of an inch (1.25 cm). Strip 12 can be provided in any suitable length, say somewhere between ten feet (3 m) and fifty feet (15 m), but it would normally be cut to size at the time of installation. Depending upon loading, after installation, the compressed areas of strip 12 can have a width greater than two inches (5 cm) and a height of a few hundredths of an inch thereby forming an excellent seal against roofing panels 16a and 16b or other corrugated or irregular surface.

Foam strip 14 is adhesively secured atop foam strip 12. Foam strip 14 is formed from closed-cell polyurethane. This material is lightweight, has a density of about one and one-half pounds per cubic foot, and is substantially impermeable to air. Prior to installation on roof 20, foam strip 14 has a width of about two inches (5 cm) and a height of about one and one-half inches (3.8 cm) and has the same length as foam strip 12. After installation on roof 20, the compressed areas of strip 14 can have a width somewhat greater than two inches (5 cm) and a negligible height thereby forming an excellent seal against trough 18 or other flat surface.

FIG. 2 shows a second universal closure 24 that permits the passage of air through itself. Closure 24 includes an elongated strip of visco-elastic foam 26 on top of which a strip of closed cell foam 28 is secured by means of a suitable adhesive. Atop foam strip 28 is adhesively secured a ventilation member 30. When, for example, closure 24 is positioned between corrugated roofing panel 16b and a ridge cap 32, strips 26 and 28 expand to fill voids formed by the ridges and hollows of roofing panel 16b whereas ventilation member 30 is pressed flush against the bottom of ridge cap 32 to permit the passage of air toward vent opening 34 between adjacent panels 16b.

Ventilation member 30 is a strip of corrugated plastic having a multiplicity of open channels 34 running the width thereof so that air can flow from one side of closure 24 to the other. Channels 34 are sized large enough to permit the easy passage of air but are small enough to inhibit the passage of insects. The height of ventilation member is preferably about one-half of an inch (1.25 cm) and the width and length thereof are the same as that of foam strip 12. Ventilation member 30 can be constructed in any suitable manner including that suggested by Sells in U.S. Pat. No. 5,427,571.

Closures 10 and 24 can be used in a variety positions on roof 20 as illustrated in FIG. 3. In addition to being affixed adjacent valley trough 18, closure 10 can be used to provide a weather-tight seal between roofing panels 16b and end walls 36. Similarly, a weather-tight seal can be provided at the junction of roofing panels 16c and a side wall 38. Likewise, closure 10 can be used beneath an eve 40 or a hip cap 42. Closure 24, however, is best suited for use beneath ridge cap 32 or in locations where vent openings 34 are well sheltered from precipitation.

In buildings constructed with a side wall 44 extending upwardly from a roofing panel 42 as shown in FIG. 6, a closure 10 can be positioned at the junction of roofing panel 42 and side wall 44 to prevent the passage of air, water and insects beneath side wall 44. Being compressed by the load-distributing floor plate 48 at the bottom of wall 44 onto the top of roofing panel 42, causes strip 12 to conform to the top of panel 42 and strip 14 to conform to the bottom of plate 48 thereby forming a perfect seal between the two.

From the foregoing, it will be appreciated that the use of universal closures 10 and 24 is straightforward. First, closures 10 and 24 are positioned, as needed, between roofing panels 16a, 16b or 16c and another building element like trough 18 or ridge cap 32. Then, threaded fasteners 48 are driven downwardly through the building element, closure and roofing panel to secure all together. Closures 10 and 24 expand to fill the openings between the ridges and hollows of the roofing panel thereby forming a weather-resistant and long-lasting seal in roof 20. No notching of closures 10 and 24 to obtain a shape that conforms with that of any corrugated roofing panels is ever required.

While the invention has been described with a high degree of particularity, it will be appreciated by those skilled in the art that modifications may be made thereto. Therefore, it is to be understood that the present invention is not limited to the sole embodiment described above, but encompasses any and all embodiments within the scope of the following claims.

I claim:

1. A universal roofing closure, comprising:
a strip of visco-elastic foam;
a strip of closed cell foam being adhesively fastened to the top of said strip of visco-elastic foam and extending the length thereof.

2. A universal roofing closure, comprising:
a strip of visco-elastic foam;
a strip of closed cell foam being adhesively fastened to the top of said strip of visco-elastic foam and extending the length thereof; and,
a ventilation member being adhesively fastened to the top of said strip of closed cell foam, said ventilation member having a multiplicity of open channels running the width thereof so that air can flow from one side of said universal closure to the other.
